(19) United States
(12) Patent Application Publication
(10) Pub. No.: US 2007/0216711 A1
(43) Pub. Date: Sep. 20, 2007

(54) Abstracting transform representations in a graphics API

(75) Inventors: Adam M. Smith, Sammamish, WA (US); Alexander Stevenson, Bellevue, WA (US); Daniel N. Wood, Seattle, WA (US); Daniel R. Lehenbauer, Redmond, WA (US); David B. Teitlebaum, Kirkland, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/374,770

(22) Filed: Mar. 14, 2006

(51) Int. Cl. G09G 5/00

(52) U.S. Cl. 345/649

(57) ABSTRACT

Various technologies and techniques are disclosed that improve the process of working with 3D rotations. Rotations are treated as a separate abstract entity from general transforms. By having rotations separate from general transforms, the user can perform the various operations on any “rotation” regardless of its encoding. An abstract 3D transform class is provided that represents a transform that can be applied to 3D a mesh or scene node, and an abstract 3D rotation class is provided which is exposed separately from other general transforms. A concrete implementation of the 3D transform class uses a 3D rotation class to apply a rotation to a 3D mesh or scene node. One or more concrete implementations of the 3D rotation class are provided which represent a separate rotation encoding.

### BACKGROUND

There are five rotation representations that are popular in computer graphics today: Euler angle sequence, axis/angle (aka rotation vector), quaternion, constraint based rotations, and 3×3 matrices. Each representation has different trade-offs and is popular in different domains. For example, Euler angles are easy for graphics designers to understand but they do not lend themselves well to key frame animation. Quaternions are ideal for key frame interpolation, but most artists do not have the mathematical background to understand them, and so on. Current graphics APIs and engines take one of two approaches to this problem: They either standardize on one representation or they use matrices as their transform representation and provide helper methods to create matrices from one or more of the above representations.

### SUMMARY

Various technologies and techniques are disclosed that improve the process of working with 3D rotations. Rotations are treated as a separate abstract entity from general transforms. By having rotations separate from general transforms, the user can perform the various operations on any “rotation” regardless of its encoding (Euler Angle Sequence, Axis/Angle, Quaternion, etc.). As a few non-limiting examples, any two rotations can be added (composed), any two rotations can be subtracted (composed by inverse), and any two rotations can be interpolated. A magnitude of a rotation can also be calculated, and interpolation between a series of rotation key frames can also be performed. In one implementation, any of the above operations can be performed on a group of rotations.

In one implementation, an abstract 3D transform class is provided that represents a transform that can be applied to 3D a mesh or scene node, and an abstract 3D rotation class is provided which is exposed separately from other general transforms. A concrete implementation (e.g. a 3D rotation transform) of an abstract 3D transform class uses a 3D rotation class to apply a rotation to a 3D mesh or scene node. One or more concrete implementations of the 3D rotation class are provided which represent a separate rotation encoding (e.g. axis angle rotation, quaternion rotation, etc.).

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a 3D transformation application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in applying rotation operations between two or more rotations.

FIG. 5 is a process flow diagram for one implementation of the system of FIG. 1 illustrating the stages involved in applying a 3D transform instance with a 3D rotation instance to a 3D mesh.

FIGS. 6-7 are logical diagrams for one implementation of the system of FIG. 1 illustrating an exemplary Rotation3D class and an exemplary RotationTransform3D class.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that improves the process of working with 3D rotations, but the system also serves other purposes in addition to these. In one implementation, one or more of the techniques described herein can be implemented as features within a 3D transformation program, or from any other type of program or service that deals with rotational transformations.

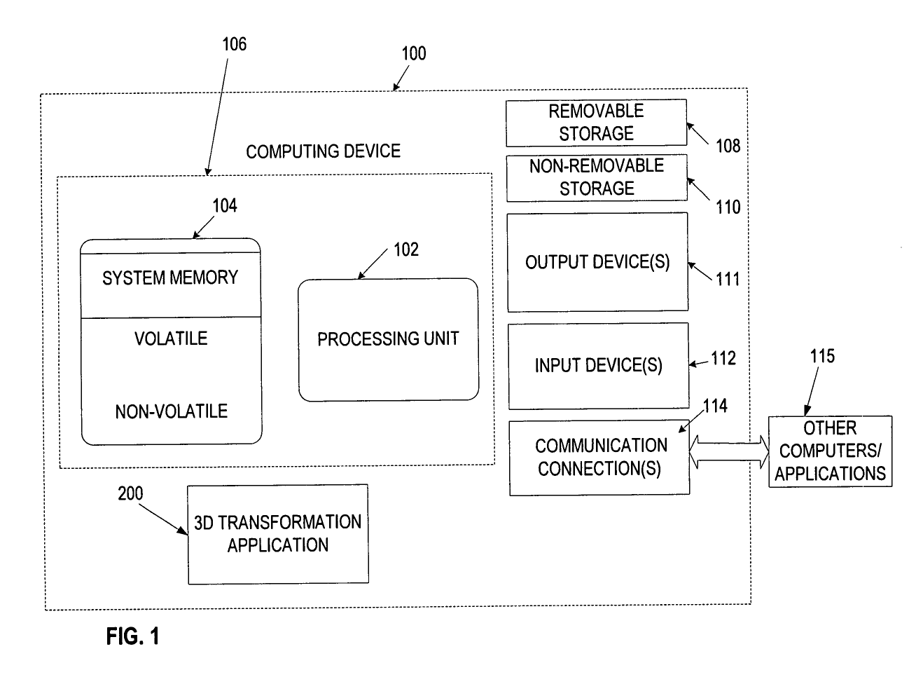

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

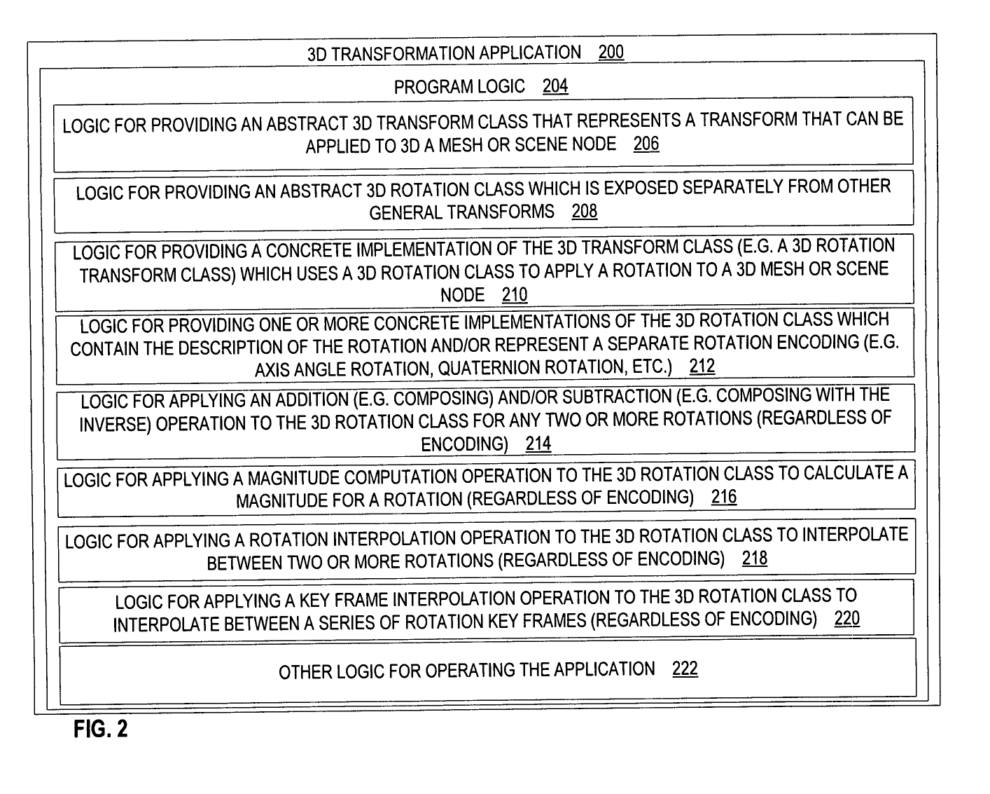

Computing device 100 includes one or more communication connections 114 that allow computing device 100 to communicate with other computers and/or applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes 3D transformation application 200, as discussed in further detail in FIG. 2.

Turning now to FIG. 2 with continued reference to FIG. 1, a 3D transformation application 200 operating on computing device 100 is illustrated. 3D transformation application 200 is one of the application programs that reside on computing device 100. However, it will be understood that 3D transformation application 200 can alternatively or additionally be embodied as computer-executable instructions on one or more computers and/or in different variations than shown on FIG. 2. Alternatively or additionally, one or more parts of 3D transformation application 200 can be part of system memory 104, on other computers and/or applications 115, or other such variations as would occur to one in the computer software art.

3D transformation application 200 includes program logic 204, which is responsible for carrying out some or all of the techniques described herein. Program logic 204 includes logic for providing an abstract 3D transform class that represents a transform that can be applied to 3D a mesh or scene node 206; logic for providing an abstract 3D rotation class which is exposed separately from other general transforms 208; logic for providing a concrete implementation of 3D transform (e.g. a 3D rotation transform) which uses a 3D rotation class to apply a rotation to a 3D mesh or scene node 210; and logic for providing one or more concrete implementations of the 3D rotation class which contain the description of the rotation and/or represent a separate rotation encoding (e.g. axis angle rotation, quaternion rotation, etc.) 212. Program logic 204 also includes logic for applying an addition (e.g. composing) and/or subtraction (e.g. composing with the inverse) operation to the 3D rotation class for any two or more rotations (regardless of encoding) 214; logic for applying a magnitude computation operation to the 3D rotation class to calculate a magnitude for a rotation (regardless of encoding) 216; logic for applying a rotation interpolation operation to the 3D rotation class to interpolate between two or more rotations (regardless of encoding) 218; logic for applying a key frame interpolation operation to the 3D rotation class to interpolate between a series of rotation key frames (regardless of encoding) 220; and other logic for operating application 222. In one implementation, program logic 204 is operable to be called programmatically from another program, such as using a single call to a procedure in program logic 204.

The examples presented herein illustrate using these technologies and techniques with a 3D graphics application in one implementation. However, as discussed previously, in other implementations these technologies and techniques are used with other systems that use rotational transformations.

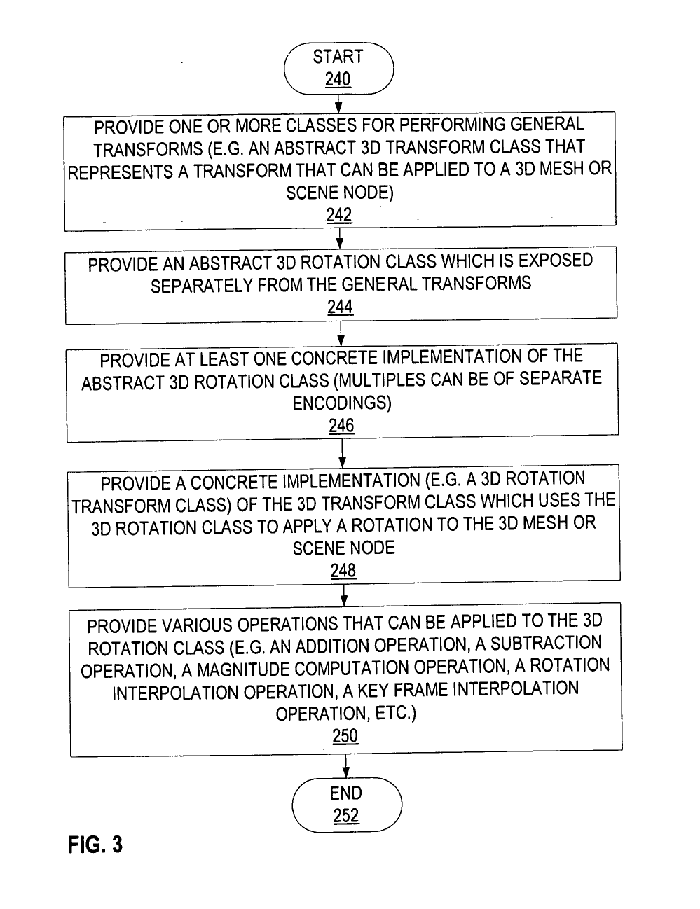

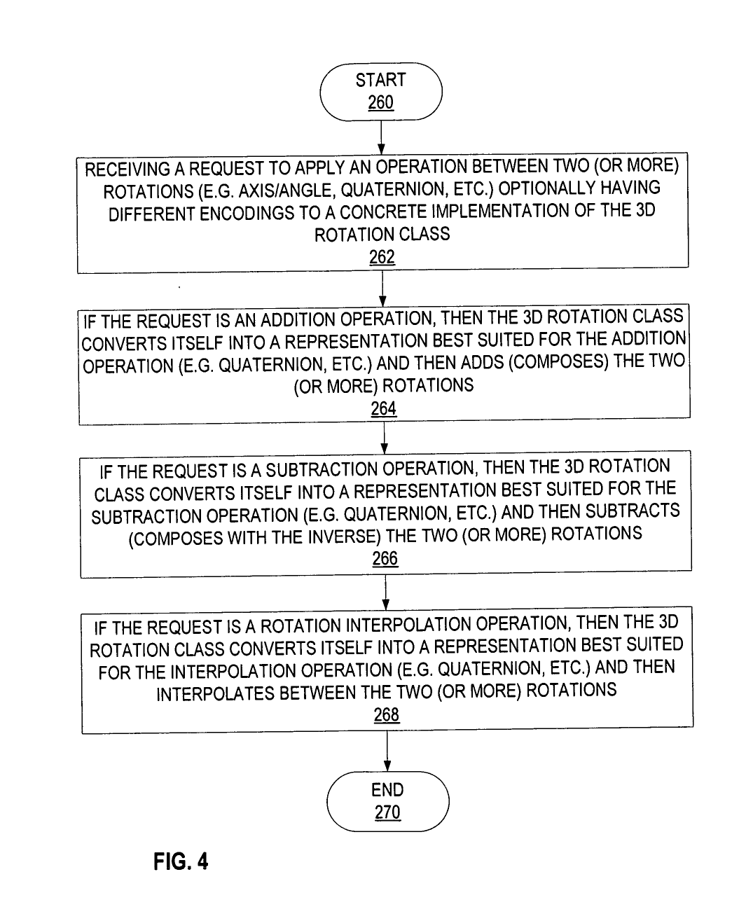

Turning now to FIGS. 3-4 with continued reference to FIGS. 1-2, the stages for implementing one or more implementations of 3D transformation application 200 are described in further detail. FIG. 3 is a high level process flow diagram for 3D transformation application 200. In one form, the process of FIG. 3 is at least partially implemented in the operating logic of computing device 100. The procedure begins at start point 240 with providing an abstract 3D transform class that represents a transform that can be applied to a 3D mesh or scene node (stage 242). An abstract 3D rotation class is provided which is exposed separately from other general transforms (stage 244). In one implementation, by having rotations separate from general transforms, the user can perform various operations discussed in further detail herein on any “rotation” regardless of its encoding (Euler Angle Sequence, Axis/Angle, Quaternion, etc.). At least one concrete implementation of the abstract 3D rotation class is provided (stage 246). These concrete implementations can be for separate encodings (stage 246). A concrete implementation of the 3D transform class (e.g. a 3D rotation transform class) which uses the 3D rotation class to apply a rotation to the 3D mesh or scene node is also provided (stage 248). Various operations are provided that can be applied to the 3D rotation class (stage 250). A few non-limiting examples of the operations include an addition operation, a subtraction operation, a magnitude computation operation, a rotation interpolation operation, and/or a key frame interpolation operation, etc. (stage 250). As discussed previously, these operations can be applied to one or more rotations regardless of their encoding. In other words, an addition operation may be performed between an axis/angle rotation and a quaternion rotation, as one non-limiting example. The process ends at end point 252.

FIG. 4 illustrates one implementation of a more detailed process for applying rotation operations between two or more rotations. In one form, the process of FIG. 4 is at least partially implemented in the operating logic of computing device 100. The procedure begins at start point 260 with receiving a request to apply an operation between two (or more) rotations (e.g. axis/angle, quaternion, etc.) to a concrete implementation of the 3D rotation class (stage 262). The two rotations can be of the same encoding, or of different encodings (stage 262). If the request is an addition operation, then the 3D rotation class converts itself into a representation best suited for the addition operation (e.g. quaternion, etc.) and then adds (composes) the two (or more) rotations (stage 264). If the request is a subtraction operation, then the 3D rotation class converts itself into a representation best suited for the subtraction operation (e.g. quaternion, etc.) and then subtracts the two (or more) rotations (composes with the inverse) (stage 266). If the request is a rotation interpolation operation, then the 3D rotation class converts itself into a representation best suited for the interpolation operation (e.g. quaternion, etc.) and then subtracts the two (or more) rotations (stage 268). In one implementation, there are multiple types of interpolation operations. In another implementation, a general grouping construct is provided that can be used to apply a group of rotations sequentially. The process ends at end point 270.

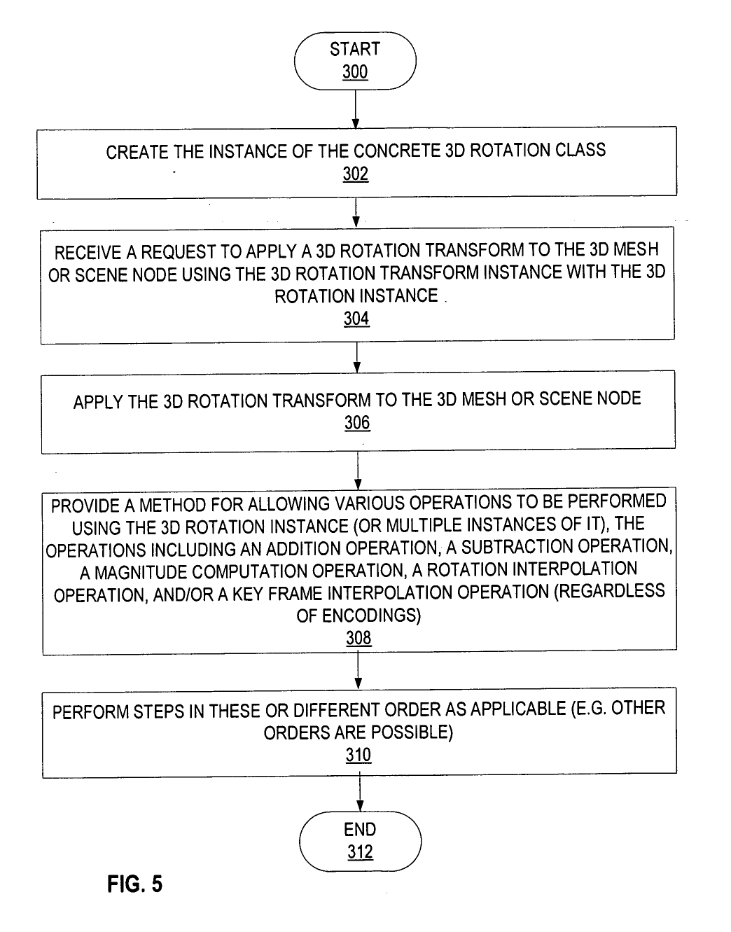

FIG. 5 illustrates the stages involved in applying a 3D transform instance with a 3D rotation instance to a 3D mesh or scene node in one implementation. In one form, the process of FIG. 5 is at least partially implemented in the operating logic of computing device 100. The process begins at start point 300 with creating an instance of the concrete 3D rotation class (stage 302). The system receives a request to apply a 3D rotation transform to the 3D mesh or scene node using the 3D rotation transform instance with the 3D rotation instance (stage 304). The 3D rotation transform is then applied to the 3D mesh or scene node (stage 306).

Methods are also provided for allowing various operations to be performed using the 3D rotation instance (or multiple instances of it where applicable) (stage 308). A few non-limiting examples of the operations include an addition operation, a subtraction operation, a magnitude computation operation, a rotation interpolation operation, and/or a key frame interpolation operation with one or more rotations (stage 308). These operations can be applied regardless of the rotation encodings. One or more of the stages described in FIG. 5 can be performed in the order described and/or in a different order, as applicable (stage 310). As one non-limiting example of a different possible order, the instance of the 3D rotation class could be created (stage 302), the operations could be applied using the 3D rotation instance (stage 308), and the result could then be set on a 3D rotation transform (stages 304 and 306). The process then ends at end point 312.

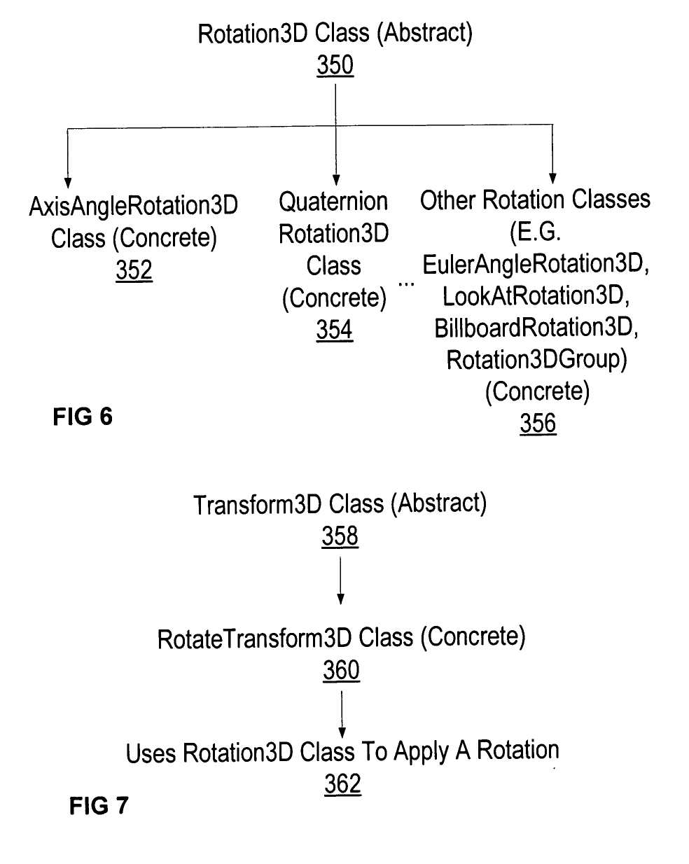

FIGS. 6-7 are logical diagrams for one implementation of the system of FIG. 1 illustrating an exemplary Rotation3D class and an exemplary RotationTransform3D class. In one implementation, Rotation3D class 350 of FIG. 6 represents the “3D rotation” class that has been discussed in the prior Figures. Rotation3D class 350 has an AxisAngleRotation3D class 352, QuaternionRotation3D class 354, and one or more other rotation classes 356 that are concrete implementations of the abstract Rotation3D class 350. A few non-limiting examples of other rotation classes 356 that can be used include EulerAngleRotation3D, LookAtRotation3D (fixed or follow), BillboardRotation3D, Rotation3DGroup, SO3MatrixRotation3D, ExponentialMapRotation3D, and/or others.

Turning now to FIG. 7, an exemplary RotationTransform3D class 360 is shown. In one implementation, RotationTransform3D class 360 is a concrete implementation of an abstract Transform3D class 358 which has been referred to as the “3D transform” class in the prior figures. Alternatively or additionally, Transform3D class 358 can have other classes than just the RotationTranform3D class 360. RotationTransform3D class 360 uses the rotation3D class (350 on FIG. 6) to apply a rotation 362. These classes or other variations of them can be used with the technologies discussed herein in one or more implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

What is claimed is:

1. A method for separating 3D rotations from general 3D transformations comprising the steps of:
providing at least one class for performing general transforms;
providing an abstract 3D rotation class which is exposed separately from the general transforms; and
providing at least one concrete implementation of the abstract 3D rotation class.

2. The method of claim 1, further comprising:
providing a plurality of operations that can be applied to the 3D rotation class.

3. The method of claim 2, wherein the plurality of operations are selected from the group consisting of an addition operation, a subtraction operation, a magnitude computation operation, a rotation interpolation operation, and a key frame interpolation operation.

4. The method of claim 2, wherein at least a portion of the plurality of operations can be performed between at least two separate rotations.

5. The method of claim 1, wherein the at least one concrete implementation of the abstract 3D rotation class comprises a plurality of concrete implementations, each of the plurality of concrete implementations representing a separate rotation encoding.

6. The method of claim 5, wherein the plurality of concrete implementations comprises a first concrete implementation and a second concrete implementation, and wherein the first concrete implementation has a first rotation encoding that is different than a second rotation encoding of the second concrete implementation.

7. The method of claim 5, wherein the separate rotation encoding is selected from the group consisting of an axis/angle encoding, a quaternion encoding, an euler angle encoding, a look at encoding, and a billboard encoding.

8. The method of claim 1, further comprising:
providing a 3D transform class that represents a transform that can be applied to a 3D mesh; and
providing a concrete implementation of the 3D transform class which uses the 3D rotation class to apply a rotation to the 3D mesh.

9. A computer-readable medium having computer-executable instructions for causing a computer to perform the steps recited in claim 1.

10. A computer-readable medium having computer-executable instructions for causing a computer to perform steps comprising:
provide an abstract 3D rotation class which is exposed separately from other general transforms;
provide a plurality of concrete implementations of the abstract 3D rotation class, each of the plurality of concrete implementations representing a separate rotation encoding; and
provide a plurality of operations that can be applied to the 3D rotation class.

11. The computer-readable medium of claim 10, wherein at least one of the operations is an addition operation between a first rotation and a second rotation.

12. The computer-readable medium of claim 11, wherein the first rotation is operable to use a first concrete implementation of the plurality of concrete implementations, the first concrete implementation having a first rotation encoding of the separate rotation encodings; and wherein the second rotation is operable to use a second concrete implementation of the plurality of concrete implementations, the second concrete implementation having a second rotation encoding of the separate rotation encodings.

13. The computer-readable medium of claim 10, wherein at least one of the operations is a subtraction operation between a first rotation and a second rotation.

14. The computer-readable medium of claim 10, wherein at least one of the operations is a magnitude computation of a rotation.

15. The computer-readable medium of claim 10, wherein at least one of the operations is an interpolation operation between a first rotation and a second rotation.

16. The computer-readable medium of claim 15, wherein the first rotation is operable to use a first concrete implementation of the plurality of concrete implementations, the first concrete implementation having a first rotation encoding of the separate rotation encodings; and wherein the second rotation is operable to use a second concrete implementation of the plurality of concrete implementations, the second concrete implementation having a second rotation encoding of the separate rotation encodings.

17. The computer-readable medium of claim 10, wherein at least one of the operations is an interpolation operation between a series of key frame animations.

18. A method for separating 3D rotations from general 3D transformations comprising the steps of:
creating an instance of a concrete 3D rotation class from an abstract 3D rotation class which is exposed separately from other general transforms;
creating an instance of a 3D transform class that represents a transform that can be applied to a 3D mesh; and
applying a rotation transform to the 3D mesh using the 3D transform instance with the 3D rotation instance.

19. The method of claim 18, wherein a plurality of operations can be performed using at least the 3D rotation instance, and wherein the plurality of operations are selected from the group consisting of an addition operation, a subtraction operation, a magnitude computation operation, a rotation interpolation operation, and a key frame interpolation operation.

20. A computer-readable medium having computer-executable instructions for causing a computer to perform the steps recited in claim 18.
